(19) United States
(12) Patent Application Publication
(10) Pub. No.: US 2024/0010843 A1
(43) Pub. Date: Jan. 11, 2024

(54) SEALING PRIMER FOR WOODWARE AND ARTICLE CONTAINING THE SEALING PRIMER LAYER FORMED BY THE SEALING PRIMER

(71) Applicant: GUANGDONG HUARUN PAINTS CO., LTD., Foshan City (CN)

(72) Inventors: Wei YANG, Foshan City (CN); Naiwo YU, Foshan City (CN); Xiaoying GAO, Foshan City (CN); Jun ZHANG, Foshan City (CN)

(21) Appl. No.: 18/037,711

(22) PCT Filed: Nov. 3, 2021
(86) PCT No.: PCT/CN2021/128387

§ 371 Date: May 18, 2023

(30) Foreign Application Priority Data
Nov. 19, 2020 (CN) 202011306723.6
Nov. 3, 2021 (WO) PCT/CN2021/128387

(51) Int. Cl. C09D 5/00; C08G 18/08; C08G 18/67

(52) U.S. Cl. CPC C09D 5/002; C08G 18/0852; C08G 18/0866; C08G 18/672; C08G 2190/00

(57) ABSTRACT

The present application relates to a sealing primer for woodware and an article containing a sealing primer layer formed by the sealing primer. In particular, the sealing primer for woodware comprises: component A, containing at least one water-dispersible isocyanate, wherein the component A has a solid content ranging from 60 to 100 wt %.

### BACKGROUND

The present application claims priority from Chinese Patent Application No. 202011306723.6, filed on Nov. 11, 2020, which is incorporated herein by reference to its entirety.

### TECHNICAL FIELD

The present application relates to a sealing primer for woodware and an article containing a sealing primer layer formed by the sealing primer. The sealing primer layer is formed on the surface of a wooden substrate and can play a role of preventing grain puffing.

### BACKGROUND

Wood products, including wooden furniture, are one of the most commonly used products in industry and life, and they are mainly made of wood substrates with capillary porous structures on the surface. Before coating, in order to obtain a smooth surface, it is usually necessary to polish the wood substrate first. However, this process inevitably results in a large amount of loosely bonded wood fibers remaining on the surface of the wood substrate. When water-based wood paint is applied to the treated substrate, water easily penetrates into the capillary of the substrate, causing the capillary to expand, causing loosely bonded fibers to protrude to the polished surface, forming an uneven surface coating, which is known as the “grain puffing” phenomenon. The existence of this phenomenon will significantly reduce the decorative effect of the coating film.

At present, the methods used to reduce or eliminate the problem of “grain puffing” caused by water-based wood paint usually include: 1) using fast-drying water-based acrylic emulsion or water-based polyurethane dispersion as film-forming resin to make paint, and controlling the grain puffing and realizing the sealing effect by its quick-drying and good penetration characteristics. Because the construction solid content is not high, the degree of cross-linking of the coating film is not high, so the filling effect is not so good, the anti-grain puffing ability is limited, and it has an impact on the transparency of the overall coating film; 2) using water-soluble acrylic resin as the film-forming resin to make paint, and using the characteristics of the self-drying to control the expansion and achieve the sealing effect. The disadvantage is that the pore-filling property is poor; the effect of anti-grain puffing on some easy-to-shrink substrates is not so good; and the VOC exceeds the standard and the smell is large.

Therefore, there is still a need to further improve the anti-grain puffing coating for wood substrates in the wood coating industry.

### SUMMARY

In an aspect, the present application provides a sealing primer for woodware, which is a one-component coating composition, comprising: component A containing at least one water-dispersible isocyanate and at least one solvent, wherein the component A has a solid content ranging from 60 to 100 wt %, preferably ranging from 65 to 90 wt %.

In another aspect, the present application provides, a sealing primer for woodware, which is a two-component coating composition comprising: component A containing at least one water-dispersible isocyanate and at least one solvent, wherein the component A has a solid content ranging from 60 to 100 wt %, preferably ranging from 65 to 90 wt %; and component B containing at least one hydroxyalkyl (meth)acrylate.

Yet another aspect of the present application provides an article comprising a wood substrate having at least one main surface; and a sealing primer layer, which is formed from the sealing primer for woodware according to the present application directly at least partially coated on the main surface of the wood substrate.

In the present application, at least one water-dispersible isocyanate is used as the main component of the sealing primer. The isocyanate group (NCO group) of the water-dispersible isocyanate can react with the hydroxyl groups and carboxyl groups in the wood. A dense coating film is formed on the surface of the wood, thereby forming a sealing primer layer on the wood, which has a function of anti-grain puffing. In addition, the sealing primer for woodware comprising component A according to the present application has a relatively high solid content and can be directly at least partially coated on the main surface of the wood substrate. The resulting sealing primer layer has both excellent anti-grain puffing effect and adhesion.

Surprisingly, the sealing primer for woodware according to the present application may further comprise a component B, which is at least one hydroxyalkyl (meth)acrylate. In this case, the sealing primer for woodware is a two-component coating composition, in which the component A and the component B have very good compatibility and application tolerance, and transparency of the dry film is excellent. After the two components are mixed, the mixture have excellent water solubility, and the equipment and tools can directly cleaned with water, which is environmentally friendly. Due to the excellent pore-filling property and wettability of the hydroxyalkyl (meth)acrylate, as the components A and B react quickly on the surface and inside of the wood, the crosslinking density of the reaction is greater, and dense and tough crosslinked structures are formed, which can effectively fix the surface of the wood, and can achieve a significantly better anti-grain puffing effect, which was difficult to foresee before the present application.

It has also been surprisingly found that the two-component sealing primer for woodware according to the present application has the following advantages compared with the traditional water-based sealing primer:
(1). Excellent pore-filling property and wettability: due to the small molecular weight and small particle size of water-soluble monomers, the sealing primer for woodware according to the present application has excellent pore penetration and wettability on various wood substrates;
(2). Excellent anti-grain puffing property: due to the excellent pore-filling property and wettability of the sealing primer for woodware according to the present application, as the A and B components react quickly on the surface and inside of the wood substrate, the resulting dense and tough cross-linked structure can effectively fix the surface of the wood substrate and prevent the grain puffing phenomenon;
(3). Excellent sealing performance: when the sealing primer for woodware according to the present application is a two-component coating composition, the crosslinking density of the reaction is high, and the isocyanate dry film itself has excellent sealing performance, water resistance, and alcohol resistance and other characteristics, so the sealing effect is excellent;
(4). Excellent filling: Since the solid content of the sealing primer for woodware according to the present application is 40 wt % to 60 wt %, it has obvious advantages compared with the traditional water-based sealing primer (20 wt %-30 wt %), and the dry film has better filling property;
(5). Due to the excellent permeability after film formation, the paint film has an excellent color rendering effect, which has a very good effect on the color of the substrate or the color of the base.

The details of one or more embodiments of the disclosure are set forth in the following description Other features, objects, and advantages of the disclosure will be apparent from the description and from the claims.

### Selected Definitions

As used herein, “a”, “an”, “the”, “at least one”, and “one or more” are used interchangeably, unless indicated otherwise. Thus, for example, a coating composition that comprises “an” additive can be interpreted to mean that the coating composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not specifically mentioned in this disclosure, as long as such components or steps do not affect the basic and novel characteristics of what is described herein, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

In this disclosure, “film-forming resin” refers to a polymer compound that can form a continuous paint film or coating under certain conditions. It can be natural or synthetic, and can be physically formed by solvent volatilization, or it can form a chemical film through a chemical cross-linking reaction. Among them, the film-forming resin for chemical film-forming is further divided into: a resin that forms a film by reacting with a curing agent, and a self-crosslinking film-forming resin. Common film-forming resins are: phenolic resin, amino resin, alkyd resin, epoxy resin, polyester resin, acrylic resin and the like. In this disclosure, the “water-dispersible isocyanate” used in the present application is usually used as a curing agent in the field of coatings, and is not a film-forming resin.

As used in the context of a wood substrate, the term “main surface” is the surface formed by the length and width dimensions of the wood substrate used to provide decoration.

As used in the context of “a coating applied on a surface or substrate”, the term “on” includes the coating at least partially directly or indirectly applied to the surface or substrate. Thus, for example, the coating applied to the primer layer on the substrate constitutes the coating applied on the substrate.

As used in the content of “sealing primer for woodware”, the term “application viscosity” refers to a viscosity at which the sealing primer for woodware can be applied normally without the application problems of hanging or too viscous.

As used in the content of “sealing primer for woodware”, the term “application solid content” refers to the non-volatile content contained in the sealing primer that can be applied normally, which usually is measured after the sealing primer is baked in an atmospheric oven at 150° C. for 1 hour. Generally, during the application process, if a mixture obtained by mixing the components of the sealing primer for woodware is too viscous, a diluent is required to be added for dilution, in order to meet the application requirement. Therefore, the application solid content is usually lower than the solid content of the sealing primer for woodware itself.

As used in the present application, the term “volatile organic compound (VOC)” refers to any carbon-containing compound that participates in atmospheric photochemical reactions except for carbon monoxide, carbon dioxide, carbonic acid, metal carbides or carbonates. Generally, volatile organic compounds have a vapor pressure of 0.1 mm Hg or higher. As used herein, “volatile organic compound content (VOC content)” refers to the weight of VOC per volume of composition or coating composition, for example, as g/L.

When appearing in this specification and claims, the terms “comprising” and “including” and variations thereof do not have a restrictive meaning.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of what is described herein.

### DETAILED DESCRIPTION

In an aspect, the present application provides a sealing primer for woodware, comprising: component A, containing at least one water-dispersible isocyanate and at least one solvent, wherein the component A has a solid content ranging from 60 to 100 wt %.

The sealing primer for woodware according to the embodiments of the present application has a relatively high solid content. In some embodiments of the present application, the solid content of component A is preferably in the range of 60-100 wt %, more preferably in the range of 65-90 wt %, still more preferably in the range of 65-85 wt %, more preferably in the range of 65-80 wt %, most preferably in the range of 65-75 wt %.

According to the embodiments, the sealing primer for woodware containing component A has a relatively high solid content, meets the VOC emission standard, and can be directly at least partially coated on the main surface of the wood substrate. The anti-grain puffing effect and adhesion of the obtained article can be comparable to the oil-based anti-grain puffing sealing coating, and the VOC emission meets environmental protection requirements.

### Water-Dispersible Isocyanate

The term “isocyanate” as used herein refers to a compound containing at least one isocyanate group (—NCO). The isocyanate may be a small molecule compound or an oligomer. The term “polyisocyanate” refers to a compound containing at least two isocyanate groups (—NCO). The isocyanate functional group can undergo chain extension and crosslinking reactions with the active hydrogen polymer, thereby forming a three-dimensional network structure in the coating. Suitable isocyanates include aliphatic polyisocyanates, aromatic polyisocyanates, or any combination thereof. The term “aliphatic polyisocyanate” as used herein refers to a polyisocyanate compound in which an isocyanate group is directly connected to an aliphatic chain or ring. The term “aromatic polyisocyanate” as used herein refers to a polyisocyanate compound in which an isocyanate group is directly connected to an aromatic ring.

As examples of suitable polyisocyanate compounds, hexamethylene diisocyanate, dodecamethylene diisocyanate, cyclohexane-1,4-diisocyanate, 4,4′-dicyclohexylmethane diisocyanate, cyclopentane-1,3-diisocyanate, p-phenylene diisocyanate, toluene-2,4-diisocyanate, naphthalene-1,4-diisocyanate, biphenyl-4,4′-diisocyanate, benzene-1,2,4-triisocyanate, xylene-1,4-diisocyanate, xylene-1,3-diisocyanate, diphenylmethane diisocyanate, butane-1,2,3-triisocyanate or polymethylene polyphenyl polyisocyanate can be used.

As examples of suitable isocyanate oligomers, polyurethane prepolymers of any of the polyisocyanate compounds listed above, polyester prepolymers of any of the polyisocyanate compounds listed above, or polyether prepolymers of any of the polyisocyanate compounds listed above can be used. The polyurethane prepolymer (for example, hexamethylene diisocyanate (HDI) trimer), polyester prepolymer or polyether prepolymer can be made by any suitable method known to those skilled in the art. For example, a polyurethane prepolymer can be made by reacting a polyol monomer with one or more of the polyisocyanate compounds under appropriate conditions; a polyester prepolymer or a polyether prepolymer can be made by reacting a polyester polyol or polyether polyol with one or more of the polyisocyanate compounds under appropriate conditions. Alternatively, as the polyurethane prepolymer, polyester prepolymer, or polyether prepolymer, any appropriate commercial product can be used. In one embodiment of the present application, the isocyanate includes hexamethylene diisocyanate (HDI) trimer.

In certain embodiments of the present application, the at least one water-dispersible isocyanate is preferably a hydrophilic group-modified and/or at least partially hydrophilic group-modified isocyanate, more preferably a hydrophilic group-modified isocyanate.

In some embodiments of the present application, the hydrophilically modified isocyanate is non-ionic hydrophilically modified or ionic hydrophilically modified, preferably ionic hydrophilically modified.

In some embodiments of the present application, the at least one water-dispersible isocyanate is derived from the group consisting of 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives thereof, and any combination thereof, preferably derived from one or more of hexamethylene diisocyanate (HDI), isophorone diisocyanate (IPDI), the dimer or trimer thereof.

Preferably, in the sealing primer for woodware according to the present application, the at least one water-dispersible isocyanate used has one or more hydrophilic groups. In some embodiments of the present application, the hydrophilic group can be in the form of an acid, such as a carboxylic acid group, a sulfonic acid group, a phosphate group, a phosphonic acid group, a phosphinic acid group, and the like. Additionally, a portion of the hydrophilic group may be in the form of an acid salt, such as a neutralized acid or anhydride, for achieving a suitable stability. Examples of suitable hydrophilic groups in the form of acid salts include carboxylate (—CO₂⁻), sulfate, phosphate, sulfonate, phosphite, phosphonate, and combinations thereof. In a preferred embodiment of the present application, the anionic hydrophilic group comprises not only an anionic hydrophilic group in the form of an acid but also an anionic hydrophilic group in the form of an acid salt. Preferably, the at least one water-dispersible isocyanate contains a sulfonate group.

Further preferably, the at least one water-dispersible isocyanate contains at least one isocyanate group and at least one alkoxysilane group, such as a water-dispersible isocyanate represented by the following formula:

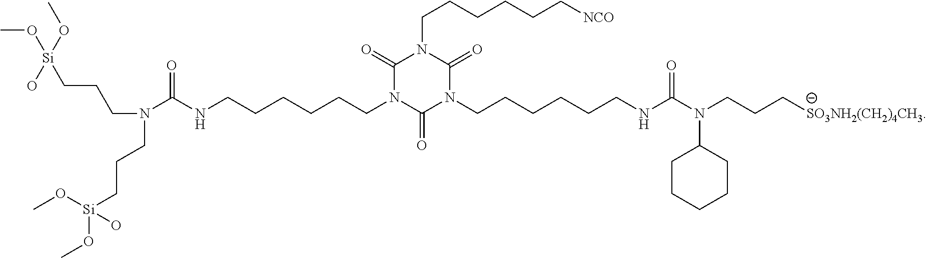

The aforementioned at least one water-dispersible isocyanate containing at least one isocyanate group and at least one alkoxysilane group is usually obtained by silane modification of a commercially available isocyanate crosslinking agent. For example, a commercially available sulfonic acid-modified isocyanate trimer is used for silane modification. Under the conditions of room temperature and stirring, the alkoxysilane is reacted with the sulfonic acid-modified isocyanate trimer to make at least a part of —NCO groups of the sulfonic acid-modified isocyanate trimer react with alkoxysilane. The use of at least one water-dispersible isocyanate containing alkoxysilane groups in the sealing primer for woodware of the present application can help to form a denser coating, thereby providing a more excellent sealing effect.

The sealing primer for woodware according to the present application comprises suitable solvents inert to the reactive groups of the isocyanate groups. Examples of suitable solvents are the customary paint solvents which are known per se, such as, e.g. ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, relatively highly substituted aromatics, of the kind commercialized, for example, under the names solvent naphtha, Solvesso®, Isopar®, Nappar® (Deutsche EXXON CHEMICAL GmbH, Cologne, DE.) and Shellsol® (Deutsche Shell Chemie GmbH, Eschborn, DE), carbonic esters such as dimethyl carbonate, diethyl carbonate, 1,2-ethylene carbonate and 1,2-propylene carbonate, lactones such as γ-propiolactone, γ-butyrolactone, ε-caprolactone and ε-methylcaprolactone, and also solvents such as propylene glycol diacetate, diethylene glycol dimethyl ether, dipropylene glycol dimethyl ether, ethylene glycol butyl ether acetate, diethylene glycol butyl ether acetate, propylene glycol monomethyl ether acetate, 1,3-dioxolane, N-methylpyrrolidone and N-methylcaprolactam, or any mixtures of such solvents.

Preferably, the at least one solvent is one or more selected from ethyl acetate, butyl acetate, xylene, toluene, propylene glycol monomethyl ether acetate, ethylene glycol butyl ether acetate, diethylene glycol butyl ether acetate, N-methylpyrrolidone, ethylene glycol monobutyl ether, acetone and methyl ethyl ketone, preferably selected from xylene and propylene glycol monomethyl ether acetate.

The inventors pioneered the use of at least one water-dispersible isocyanate as the main component of the sealing primer, by utilizing the NCO group of the at least one water-dispersible isocyanate to react with the hydroxyl and carboxyl groups in the wood to form a dense paint film on the surface of the wood. Thus, an anti-grain puffing sealing layer is formed on the wood.

In some embodiments of the present application, in addition to component A, the sealing primer for woodware further comprises component B containing at least one hydroxyalkyl (meth)acrylate. In this case, the sealing primer for woodware is a two-component coating composition. Preferably, the at least one hydroxyalkyl (meth)acrylate is a hydroxy C1-C20 alkyl (meth)acrylate. More preferably, the at least one hydroxyalkyl (meth)acrylate is a water-soluble hydroxy C1-C20 alkyl (meth)acrylate. Examples of suitable hydroxy C1-C20 alkyl (meth)acrylates include, but are not limited to, hydroxyethyl methacrylate, hydroxypropyl methacrylate, hydroxyethyl acrylate, hydroxypropyl acrylate, or any combination thereof. Preferably, the at least one hydroxyalkyl (meth)acrylate is selected from at least one of hydroxyethyl (meth)acrylate and hydroxypropyl (meth)acrylate. More preferably, it is selected from hydroxyethyl (meth)acrylate. Preferably, component B is at least one hydroxyalkyl (meth)acrylate, more preferably a hydroxy C1-C20 alkyl (meth)acrylate, and most preferably a hydroxyethyl (meth)acrylate. In some embodiments of the present application, the solid content of component B is 100 wt %.

In the case where the wood sealing primer is a two-component coating composition, the weight ratio of the component A to the component B is in the range of 1.5:1 to 3:1, preferably 2:1 to 3:1, more preferably in the range of 2.5:1 to 3:1.

It has been found that the two-component coating composition uses at least one water-dispersible isocyanate as component A and at least one hydroxyalkyl (meth)acrylate (water-soluble monomer) as component B. The component A and the component B have very good compatibility and application tolerance, and transparency of the dry film is excellent. After the two components are mixed, the mixture have excellent water solubility, and the equipment and tools can directly cleaned with water, which is environmentally friendly. In addition, when the weight ratio of the two components meets the above range, the construction solid content of the sealing primer for woodware according to the present application is between 40 wt %˜60 wt %, which has obvious advantages over traditional water-based sealing primer (the construction solid content range is usually 20 wt %-30 wt %), and the dry film has better filling properties.

In some embodiments according to the present application, the sealing primer for woodware is substantially free of film-forming resin. The term “substantially free” of a certain compound means that the coating and/or composition of the present application contains less than 5 wt % of the compound.

The sealing primer for woodware according to the present application may optionally contain one or more fillers. The term “filler” as used herein refers to any volume extender suitable for coatings, which may be organic or inorganic, for example, in the form of particles. There is no particular limitation on the shape of the particles, and they can have any appropriate shape. The average particle size of the filler can vary within a wide range, for example within a range of about 10 nanometers to about 50 microns. Some fillers, in addition to functioning as volume extenders, also impart one or more desired properties to the composition and/or the coating formed from the composition. For example, some fillers can impart the desired color to the composition and the coating resulting from the composition. In this case, this filler is also called “pigment”. Some fillers can improve the chemical and/or physical properties, especially the mechanical properties of the coating obtained from the composition. In this case, such filler is also called “reinforcing filler”.

The sealing primer for woodware according to the present application may optionally comprise additional additives commonly used in coating composition, and these additives will not adversely affect the coating composition or the cured coating obtained therefrom. Suitable additives include, for example, those that can be used to improve the processability or manufacturability of the composition, enhance composition aesthetics, or improve a particular functional property or characteristic of the coating composition or the cured composition resulting therefrom, such as adhesion to a substrate. Suitable examples of the additive include, such as carriers, film forming auxiliaries, co-solvents, pigments, fillers, anti-migration aids, antibacterial agents, chain extenders, lubricants, wetting agents, biocides, plasticizers, antifoaming agent, coloring agent, wax, antioxidant, anticorrosive, flow control agent, thixotropic agent, dispersant, adhesion promoter, UV stabilizer, thickener, defoamer, pH adjuster, silane coupling agent, high-boiling point film-forming aid or combination. The content of each optional ingredient is sufficient to achieve its intended purpose, but preferably such an amount does not adversely affect the coating composition or the cured coating obtained therefrom.

In an embodiment according to the present application, the two-component sealing primer for woodware comprises, relative to the total weight of the sealing primer for woodware, 25-40 wt % of the component A; 60-75 wt % of the component B; and 0-15 wt % of additional additives.

In one embodiment of the present application, the two-component wood sealing primer still has a construction solid content of 40 to 60 wt % when it reaches a construction viscosity of 30s or lower.

In a preferred embodiment of the present application, the two-component sealing primer for woodware has a construction solid content of 40 to 60 wt % when it reaches a construction viscosity of 30s or lower, and at the same time has a volatile organic compound (VOC) content of 600 g/L or lower.

According to the present application, the preparation of the one-component sealing primer for woodware can be achieved by any suitable method known to those skilled in the art. For example, a sealing primer for woodware can be made by adding all the ingredients to a container, and then stirring the resulting mixture until uniform. Or the sealing primer for woodware can be made by mixing part of the ingredients first, and then adding the remaining ingredients to form a uniform mixture.

According to the present application, the two-component sealing primer for woodware can be prepared by simply mixing the component A and the component B in a mixing device in a predetermined weight ratio before application.

According to the present application, the sealing primer for woodware can be coated by a conventional coating method known to those skilled in the art. The coating method includes dip coating, spin coating, spray coating, curtain coating, brush coating, roll coating, and other coating methods known in the art. In one embodiment of the present application, the sealing primer for woodware is coated by spraying. The sealing primer for woodware can be coated in various wet film thicknesses. In the embodiment of the present application, the coating amount of the sealing primer for woodware is in the range of 30-100 g/m², preferably in the range of 50-90 g/m², more preferably in the range of 60-80 g/m². The applied coating can be cured by air-drying or by using various drying devices (for example, an oven) familiar to those skilled in the art to accelerate the curing.

In the present application, the sealing primer for woodware can be used as it is, at least partially coated on a substrate to form a coating, and is preferably used as a primer layer to directly contact the substrate. Therefore, the present application also relates to an article comprising (a) a wood substrate having at least one main surface; (b) a sealing primer layer, which is formed from the sealing primer for woodware according to the present application coated on the main surface coated of the wood substrate. At least one additional sealing primer layer coated on the sealing primer layer is also contemplated.

In the article according to the present application, one or more coatings formed of an aqueous coating composition may be at least partially coated on the surface of the sealing primer layer. According to the present application, the coating may include a primer coating, an intermediate coating, a top coating or a combination thereof. The coating can be directly applied on the sealing primer layer, and directly in contact with the sealing primer layer. In some embodiments of the present application, one or more colorant layers may be present between the coating formed by the aqueous coating composition and the sealing primer layer, so as to obtain the desired color.

According to the present application, two or more coatings formed from an aqueous coating composition can be applied on the sealing primer layer, preferably 3 or more coatings formed from an aqueous coating composition are applied, more preferably 4 or more coatings formed from an aqueous coating composition are applied, without affecting the barrier effect of the sealing primer layer.

Yet another aspect of the present application provides an article comprising (a) a wood substrate having at least one main surface; (b) a sealing primer layer, which is formed from the sealing primer for woodware according to the present application applied on the main surface coated of the wood substrate; and (c) a coating layer formed from an aqueous coating composition applied on the sealing primer layer.

As the wood substrate used to manufacture the article of the present application, any suitable wood substrate known in the art can be used. According to the present application, the wood substrate has at least one, preferably two main surfaces facing each other. As used herein, the “main surface” is the surface for decoration formed by the length and width dimensions of the wood substrate.

Preferably, the main surface of the wood substrate may have polar groups such as hydroxyl, amino, sulfhydryl, etc. As a result, when the sealing primer for woodware of the present application is applied on it, the at least one water-dispersible isocyanate in the coating composition can easily wet the surface to form a coating on the surface of the substrate. Methods for making a wood substrate to have a main surface with hydroxyl groups are known in the art. Specifically, the main surface of the wood substrate may be subjected to surface treatment, such as oxidation by corona treatment, so as to introduce hydroxyl groups on the surface of the wood substrate.

According to the present application, the wood substrate includes softwood or hardwood or a combination thereof. As examples of softwood, pine, cedar, or cypress can be used. As examples of hardwoods, manchurian ash, ash wood, basswood, elm, maple, birch, alder, beech, oak, cherry, walnut, or mahogany can be used. In one embodiment of the present application, a solid ebony wood board is used as the wood substrate.

According to the present application, the sealing primer for woodware can be applied by a conventional coating method known to a person of ordinary skill in the art. The coating method includes dip coating, spin coating, spray coating, curtain coating, brush coating, roll coating, and other coating methods known in the art. In one embodiment of the present application, the application is performed using a spraying process.

According to the present application, the article can be prepared, for example, by: (1) providing a polished wood substrate; (2) using a spraying process to apply the sealing primer for woodware according to the present application on the wood substrate to form a sealing primer layer; (3) using a wet-to-dry coating process, one or more coatings formed from the aqueous coating composition are sequentially coated on the sealing primer layer to formed the desired coating. Optionally, the colorant may be applied on the sealing primer layer before step (3), so as to provide the wood substrate with the desired color.

According to the present application, the wood article thus obtained can be used for the following applications, including, but not limited to: household furniture, such as tables, chairs, cabinets, and the like; bedroom and bathroom furniture; office furniture; custom furniture, such as school and children's furniture, hospitals furniture, restaurant and hotel furniture, kitchen cabinets and furniture; panels for interior design; indoor and outdoor windows and doors; indoor and outdoor window and door frames; outdoor and indoor wall panels and wooden floors.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### Examples

Testing Methods

Transparency: Films were formed from the coating composition under the same substrate and process conditions, and the transparency of each coating was visually compared. The transparency was classified into three rates: “high”, “fair” and “poor”.

Adhesion: According to the ASTM D3359 standard, the adhesion was determined by the cross-cut method and evaluated according to three rate: “good”, “fair” and “poor”.

Solid content: The amount of remaining components was measured after baking the sample in an atmospheric oven at 150° C. for 1 hour to determine the solid content.

Construction solid content: a certain amount of water or at least one solvent was used to dilute the sample to be tested, and then the sample to be tested was measured according to the test method used to test the solid content.

Construction viscosity: as required, a certain amount of water was used to dilute the sample to be tested, and then an Iwata 4 # cup was used to test its viscosity.

VOC content was measured according to the standard HJ2537-2014

Constructability: According to whether the gun was blocked during spraying, the effect of atomization, the wetting effect and leveling after spraying were judged manually, and the evaluation was carried out according to three rated of “good”, “fair” and “poor”.

Application performance: manual judgments was made based on whether the gun was blocked during spraying, atomization effect, wetting effect and leveling after spraying. The application performance was classified into three rates: “high”, “fair” and “poor”.

### Treatment of Wood Substrates

Solid ebony wood boards available from the timber market were dried in a kiln. A sample with a size of 15 cm*15 cm*1.5 cm was taken from the dried board, and kept under the conditions of a temperature of 25° C., a relative humidity (RH) of 60% and an air flow rate of 1.8 m/s to constant weight, in which the equilibrium moisture content of the sample was 11%. A strip sander was used to sand the sample with No. 180 sandpaper purchased from 3M^{T} Utility Cloth Sheet and the sample was cleaned with an air gun.

### Materials

The materials used are listed in Table 1 below.

TABLE 1

| | Material |
|---|---|
| Name | Number |
| Water-dispersible isocyanate derived from isophorone | 1 |
| diisocyanate (IPDI) | |
| Water-dispersible isocyanates derived from HDI and TDI | 2 |
| Water-dispersible isocyanate derived from HDI | 3 |
| Water-dispersible isocyanate derived from HDI | 4 |
| Water-dispersible isocyanate derived from TDI | 5 |
| Water-dispersible isocyanate derived from HDI | 6 |
| Water-dispersible isocyanate derived from HDI and TDI | 7 |
| Hydroxyethyl methacrylate, water-soluble hydroxyalkyl | 8 |
| (meth)acrylate | |
| Hydroxypropyl methacrylate, water-soluble hydroxyalkyl | 9 |
| (meth)acrylate | |
| Hydroxybutyl methacrylate, non-water-soluble hydroxyalkyl | 10 |
| (meth)acrylate | |
| WK8000B, a commercially available water-based acrylic | 11 |
| emulsion system for sealing from Guangdong Huarun Paint CO. | |
| Ltd. | |
| WK1000B, a commercially available water-soluble acrylic resin | 12 |
| system for sealing from Guangdong Huarun Paint CO. Ltd. | |
| WTD8500, a commercially available water-based two- | 13 |
| component primer from Guangdong Huarun Paint CO. Ltd. | |
| WT85033, commercially available water-based two-component | 14 |
| topcoat from Guangdong Huarun Paint CO. Ltd. | |

### Example 1-8: One-Component Sealing Primer for Woodware

The one-component sealing primer for woodware of the present application was formulated, and the at least one water-dispersible isocyanate and optionally at least one solvent were mixed to form the sealing primer for woodware of the present application.

Then, the sealing primer for woodware of the present application was sprayed on the treated sample, and dried in air for 15 minutes, in an oven at 40° C. for 1 hour, and then cooled in air for 30 minutes, and then visual inspection was used to determine the protection anti-grain puffing effect.

Example 8 used a self-made water-dispersible isocyanate containing at least one alkoxysilane group, and the chemical structural formula was shown below. The preparation of the self-made water-dispersible isocyanate was as follows: under the conditions of room temperature and stirring, bis(3-trimethoxysilylpropyl)amine was reacted with a commercially available sulfonic acid-modified isocyanate trimer (Material No. 3) at a molar ratio of 2:1 to obtain silane-modified isocyanate.

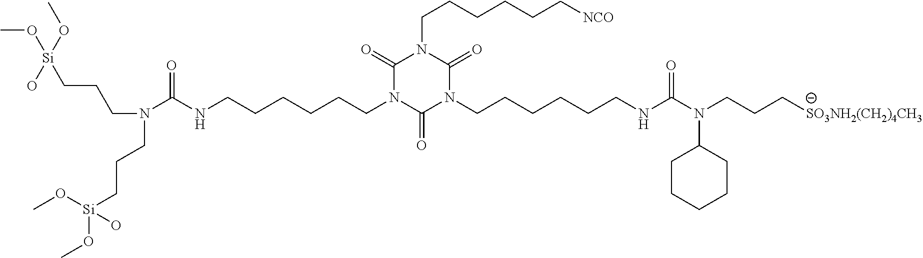

Table 2 below summarized the composition and anti-grain puffing effect of the on-component sealing primer for woodware of the present application.

TABLE 2

| | Example 1 | Example 2 | Example 3 | Example 4 | Example 5 | Example 6 | Example 7 | Example 8 |
|---|---|---|---|---|---|---|---|---|
| Component A- | 2 | 7 | 3 | 4 | 5 | 6 | 1 | Self-made |
| Material Number | | | | | | | | water- |
| | | | | | | | | dispersible |
| | | | | | | | | isocyanate |
| | | | | | | | | containing at |
| | | | | | | | | least one |
| | | | | | | | | alkoxysilane |
| | | | | | | | | group |
| Solid content (wt %) | 70 | 70 | 100 | 100 | 70 | 100 | 70 | 70 |
| Anti-grain puffing | No grain | No grain | No grain | No grain | No grain | No grain | No grain | No grain |
| | puffing | puffing | puffing | puffing | puffing | puffing | puffing | puffing |
| Adhesion | Good | Good | Fair | Good | Good | Good | Good | Good |
| VOC content (g/L) | 300 | 300 | 0 | 0 | 300 | 0 | 300 | 300 |

It can be seen from the results in Table 2 that the inventor pioneered the use of at least one water-dispersible isocyanate as the main component of the sealing primer, without using film-forming resin components, the isocyanate groups of the water-dispersible isocyanate can react with the hydroxyl group, carboxyl group, etc. in the wood substrate to form a dense paint film on the surface of the wood, thereby forming a sealing primer layer on the wood, which had a function of anti-grain puffing. In addition, although the one-component wood sealing primer according to the present application had a relatively high solid content, it can be directly sprayed on the main surface of the wood substrate, and the resulting sealing primer layer has both excellent anti-grain puffing effect and adhesion.

### Example 9-10: Two-Component Sealing Primer for Woodware

The sealing primer for woodware according to what is described herein may further comprise a component B, which was a hydroxyalkyl (meth)acrylate. In this case, the sealer primer for woodware was a two-component coating composition.

In order to study the effect of component B on the sealing primer for woodware of the present application, according to the components shown in Table 3, different small molecular weight alcohols and hydroxyalkyl (meth)acrylates and component A were used, to combine with the at least one water-dispersible isocyanate. Then the obtained two-component coating composition was tested for construction solid content, miscibility, VOC content, construction viscosity, coating amount, and then the coating was dried at 50° C. for 1 hour to determine the surface drying time, pressure drying time and film-forming property. The results were shown in Table 3:

TABLE 3

| | | | Comparative | Comparative | Comparative |
|---|---|---|---|---|---|
| | Example 9 | Example 10 | Example 1 | Example 2 | Example 3 |
| Component A | Material No. | Material No. | Material No. | Material No. | Material No. |
| | 1 | 1 | 1 | 1 | 1 |
| Component B | Hydroxyethyl | Hydroxypropyl | Hydroxybutyl | N-propanol | 1,4- |
| | methacrylate | methacrylate | methacrylate | | butanediol |
| Weight ratio | 2:1 | 2:1 | 2:1 | 2:1 | 2:1 |
| of A:B | | | | | |
| Construction | 47 | 47 | 47 | 47 | 47 |
| solid content | | | | | |
| (wt %) | | | | | |
| Miscibility | Good | Good | Poor | Good | Good |
| VOC content | 550 | 550 | Not tested | 550 | 550 |
| (g/L) | | | | | |
| Construction | 30″ | 35″ | Not tested | 30″ | 50″ |
| viscosity (T-4) | | | | | |
| Coating | 60 | 60 | Not tested | 60 | 60 |
| amount (g/m²) | | | | | |
| Surface | 15 min | 15 min | Not tested | 13 min | 5 min |
| drying time | | | | | |
| Pressure | 30 min | 20 min | Not tested | 26 min | 10 min |
| drying | | | | | |
| In-tank | Normal | Normal | Not tested | Fast reacting, | Fast reacting, |
| reaction | | | | fast viscosity | lots of |
| | | | | rise | bubbles |
| Film-forming | Good | Good | Not tested | White paint | White paint |
| property | | | | film | film with |
| | | | | | lots of |
| | | | | | bubbles |

After testing, the small molecular weight alcohol reacted too fast with the IPDI-type hydrophilic modified aliphatic isocyanate, prone to generate a large number of bubbles, and there was a problem of film formation. Therefore, it cannot be used for the sealing primer for woodware according to the present application. The water-soluble hydroxyethyl methacrylate and hydroxypropyl methacrylate had good compatibility with the IPDI type hydrophilic modified aliphatic isocyanate, so the paint film obtained had excellent properties. Hydroxybutyl methacrylate was not suitable for this application due to its relatively large molecular weight, insoluble in water, and poor compatibility and washing performance.

In order to further study the influence of the different proportions of the component A and the component B on the sealing primer for woodware of the present application, hydroxyethyl methacrylate and Bayhydur 401-70 were added to a container in different ratios according to Table 4 and mixed, then stirred at 800-1000 rpm until uniform, thereby forming the sample to be tested. The constructability and film-forming properties of the samples were tested, and the results were as follows:

TABLE 4

| | A: Material No. 1 | | | | |
|---|---|---|---|---|---|
| | B: Hydroxyethyl methacrylate | | | | |
| | A:B = | A:B = | A:B = | A:B = | A:B = |
| | 1:1 | 1.5:1 | 2:1 | 2.5:1 | 3:1 |
| Solid content | 35% | 42% | 47% | 50% | 52.5% |
| VOC(g/L) | 650 | 580 | 530 | 500 | 475 |
| Constructability | Good | Good | Good | Fair | Fair |
| Film-forming property | Poor | Good | Good | Good | Good |

Therefore, in the case that the wood sealer was a two-component coating composition, the weight ratio of the component A to the component B in the range of 1.5:1 to 3:1 can achieve a relatively good construction effect.

In order to further verify the anti-grain puffing effect of the sealing primer for woodware of the present application, according to the following construction parameters, the two-component sealing primer for woodware of Example 9 of the present application and the conventional water-based sealing products WK8000B and WK1000B were respectively applied on the ebony wood substrate to form a primer coating layer, thereby forming the sample to be tested.

Table 5 below summarized the composition, construction parameters and test results of the two-component sealing primer for woodware of the present application and the water-based sealing product for comparison.

TABLE 5

| | | Comparative | Comparative |
|---|---|---|---|
| No. | Example 9 | Example 4 | Example 5 |
| Description | High solid content | WK8000B | WK1000B |
| | two-component | | |
| | sealing primer | | |
| Ratio of | 2:1 | / | / |
| component A and | | | |
| component B | | | |
| Construction solid | 47 | 28 | 18 |
| content (%) | | | |
| VOC(g/L) | 550 | 220 | 800 |
| Construction | 30″ | 40″ | 45″ |
| viscosity (T-4) | | | |
| Coating amount | 60 | 60 | 60 |
| (g/m²) | | | |
| Drying conditions | Baking at 50° C. for 30 min | | |
| Anti-grain puffing | Excellent | Fair | Good, slight |
| effect | | | grain-puffing |
| Pore-filling effect | Excellent | Fair, swelling | Fair, swelling |
| | | at the duct | at the duct |
| Transparency | High | Poor | Fair |

From the results in Table 5, it can be seen that the construction solid content of the two-component sealing primer for woodware according to the present application was between 40 wt %˜60 wt %, which has obvious advantaged than the traditional water-based sealing primer (20 wt %˜30 wt %). In addition, the dry film had excellent pore-filling effect and excellent anti-grain puffing effect, and had excellent permeability after film formation.

Coating

The two-component sealing primer for woodware prepared according to the above Example 9 of the present application, WK8000B from Guangdong Huarun Paint CO. Ltd. and WK1000B from Guangdong Huarun Paint CO. Ltd. were respectively diluted with DPM or water as shown in the following Table 6, and the diluted mixture was applied on the surface of ebony wood substrate as the first sealing primer, and then the universal water-based two-component primer WTD8500 was applied as the second primer and universal water-based two-component topcoat WT85033 was applied as the third primer. The construction parameters of the first primer were shown in Table 3 above, and the test results of the entire coating were summarized in Table 6.

TABLE 6

| | | Comparative | Comparative |
|---|---|---|---|
| | Test example | Example 6 | Example 7 |
| Sealing primer | Material No. 1: | WK8000B | WK1000B |
| | Hydroxyethyl | | |
| | methacrylate = 2:1 | | |
| Transparency | Excellent | Poor | Fair |
| Color effect | Excellent, clear, | Poor, hazy | Poor, hazy |
| | bright color | board | board |
| Pore-filing | Excellent, the duct was | Fair, swelling | Fair, swelling |
| effect | smooth and natural | at the duct | at the duct |
| Resistance | Excellent | Excellent | Excellent |

It can be seen from the test results in Table 6 that the two-component sealing primer for woodware according to the present application had a higher crosslinking density, and can achieve excellent anti-grain puffing and sealing effects, and had excellent compatibility with the conventional water-based two-component primer and topcoat, which further improved the transparency of the entire paint film. In addition, the obtained paint film had excellent color effects, and had a very good effect on the development of the color of the substrate or the color of the base.

### Embodiments

Embodiment 1: A sealing primer for woodware, comprising: component A, containing at least one water-dispersible isocyanate, wherein the component A has a solid content ranging from 60 to 100 wt %.

Embodiment 2: An embodiment of Embodiment 1, wherein the component A has a solid content ranging from 65 to 90 wt %.

Embodiment 3: An embodiment of any of Embodiments 1-2, wherein the at least one water-dispersible isocyanate is derived from 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives and any combination thereof, preferably derived from one or more of hexamethylene diisocyanate (HDI), isophorone diisocyanate (IPDI), the dimer or trimer thereof.

Embodiment 4: An embodiment of any of Embodiments 1-3, wherein the at least one water-dispersible isocyanate contains a sulfonate group.

Embodiment 5: An embodiment of any of Embodiments 1-3, wherein the at least one water-dispersible isocyanate contains an alkoxysilane group.

Embodiment 6: An embodiment of any of Embodiments 1-5, wherein the component A further comprises at least one solvent.

Embodiment 7: An embodiment of Embodiment 6, wherein the at least one solvent is one or more selected from ethyl acetate, butyl acetate, xylene, toluene, propylene glycol monomethyl ether acetate, ethylene glycol butyl ether acetate, diethylene glycol butyl ether acetate, N-methylpyrrolidone, ethylene glycol monobutyl ether, acetone and methyl ethyl ketone.

Embodiment 8: An embodiment of any of Embodiments 1 to 7, further comprising: component B, containing at least one hydroxyalkyl (meth)acrylate.

Embodiment 9: An embodiment of Embodiment 8, wherein the at least one hydroxyalkyl (meth)acrylate is a water-soluble hydroxyalkyl (meth)acrylate.

Embodiment 10: An embodiment of any of Embodiments 8-9, wherein the weight ratio of the component A to the component B is in the range of 1.5:1 to 3:1.

Embodiment 11: An embodiment of any of Embodiments 8-10, wherein the sealing primer for woodware has a construction solid content of at least 40%.

Embodiment 12: An embodiment of any of Embodiments 8-11, wherein the at least one hydroxyalkyl (meth)acrylate is selected from one or more of hydroxyethyl methacrylate, hydroxypropyl methacrylate, hydroxyethyl acrylate and hydroxypropyl acrylate.

Embodiment 13: An embodiment of any of Embodiments 1 to 12, wherein the sealing primer for woodware is substantially free of film-forming resins.

Embodiment 14: An article, comprising: a wood substrate having at least one main surface; and a sealing primer layer, which is formed from the sealing primer for woodware according to any one of Embodiments 1 to 13 at least partially coated on the main surface.

Embodiment 15: An embodiment of Embodiment 14, wherein the sealing primer for woodware has a coating amount ranging from 30 to 100 g/m²

While what has been described herein with respect to a number of embodiments and examples, those skilled in the art, having benefit of this disclosure, will appreciate that other embodiments can be devised which do not depart from the scope and spirit of what is disclosed herein.

What is claimed is:

1. A sealing primer for woodware, comprising:
component A, containing at least one water-dispersible isocyanate, wherein the component A has a solid content ranging from 60 to 100 wt %.

2. The sealing primer for woodware according to claim 1, wherein the component A has a solid content ranging from 65 to 90 wt %.

3. The sealing primer for woodware according to claim 1, wherein the at least one water-dispersible isocyanate is derived from 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives and any combination thereof, preferably derived from one or more of hexamethylene diisocyanate (HDI), isophorone diisocyanate (IPDI), the dimer or trimer thereof.

4. The sealing primer for woodware according to claim 1, wherein the at least one water-dispersible isocyanate contains a sulfonate group.

5. The sealing primer for woodware according to claim 1, wherein the at least one water-dispersible isocyanate contains an alkoxysilane group.

6. The sealing primer for woodware according to claim 1, wherein the component A further comprises at least one solvent.

7. The sealing primer for woodware according to claim 6, wherein the at least one solvent is one or more selected from ethyl acetate, butyl acetate, xylene, toluene, propylene glycol monomethyl ether acetate, ethylene glycol butyl ether acetate, diethylene glycol butyl ether acetate, N-methylpyrrolidone, ethylene glycol monobutyl ether, acetone and methyl ethyl ketone.

8. The sealing primer for woodware according to claim 1, further comprising:
component B, containing at least one hydroxyalkyl (meth)acrylate.

9. The sealing primer for woodware according to claim 8, wherein the at least one hydroxyalkyl (meth)acrylate is a water-soluble hydroxyalkyl (meth)acrylate.

10. The sealing primer for woodware according to claim 8, wherein the weight ratio of the component A to the component B is in the range of 1.5:1 to 3:1.

11. The sealing primer for woodware according to claim 8, wherein the sealing primer for woodware has a construction solid content of at least 40%.

12. The sealing primer for woodware according to claim 8, wherein the at least one hydroxyalkyl (meth)acrylate is selected from one or more of hydroxyethyl methacrylate, hydroxypropyl methacrylate, hydroxyethyl acrylate and hydroxypropyl acrylate.

13. The sealing primer for woodware according to claim 1, wherein the sealing primer for woodware is substantially free of film-forming resins.

14. An article, comprising:
a wood substrate having at least one main surface; and
a sealing primer layer, which is formed from the sealing primer for woodware according to claim 1 at least partially coated on the main surface.

15. The article according to claim 14, wherein the sealing primer for woodware has a coating amount ranging from 30 to 100 g/m².
